(19) United States
(12) Patent Application Publication
(10) Pub. No.: US 2005/0081166 A1
(43) Pub. Date: Apr. 14, 2005

(54) System and method facilitating automated navigation for user interface(s)

(76) Inventors: Michael A. Stokke, Snohomish, WA (US); Walter B. Isidro, Kirkland, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 10/684,912

(22) Filed: Oct. 14, 2003

(51) Int. Cl. G06F 3/00; G06F 9/00; G06F 17/00

(52) U.S. Cl. 715/851

(57) ABSTRACT

A system and method for facilitating user interface automation is provided. The system facilitates creation of user interface automation (e.g., Wizard(s)), for example, by programmer(s) and/or tester(s). The system is based on an architecture which separates data, command(s) and the executable(s), thus facilitating a modular system which can be modified without recompilation of the executable(s). The system mitigates recompilation of executable(s) as information (e.g., data and/or command(s)) associated with program flow are generally stored in simple text file(s) thus reducing the need to recompile the executable(s). The system includes an input component that receives a request (e.g., command line invocation), and, a navigation component that performs the simulated user interface. The navigation component retrieves mapping information (e.g., section name(s) and page identifier(s)) from a map information store (e.g., map file) and command information (e.g., action(s) to be performed for specific page identifier(s)) from a command information store (e.g., command file).

### TECHNICAL FIELD

The present invention relates generally to user interface (e.g., wizards), and more particularly, to a system and method for facilitating user interface automation.

### BACKGROUND OF THE INVENTION

User interface(s) (e.g., wizard(s)) have proven an effective means for performing many computer-related tasks, for example, installation of software component(s), hardware component(s) and providing assistance in performance of repeatable task(s) for individual user(s). However, testing of user interface(s) for various scenarios has proven difficult. Frequently, the various scenarios are coded and compiled which can be a time-consuming task.

Additionally, employment of user interface(s) for wide-scale installations can be frustrating. For example, selections for substantially all users of a particular software program within a corporate division can be the same, except for a “user name” field on one of fifty user interface screens. Conventionally, a user manually viewed the screens carefully entering the same data and/or controls, except for the screen having the “user name” field. Thus, conventional methods have proven ineffective, time consuming and frustrating.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention provides for user interface (UI) automation system and method. The system facilitates creation of user interface automation (e.g., Wizard(s)), for example, by programmer(s) and/or tester(s). The system is based on an architecture which separates data, command(s) and the executable(s), thus facilitating a modular system which can be modified without recompilation of the executable(s).

The ability to make modification(s) quickly and efficiently is desirous in user interface automation system(s). Conventional UI automation tool(s) have depended on external dynamic link library(ies) (“DLLs”) which necessitated recompilation in order to make modification(s). Further, many conventional UI automation tool(s) include an engine that drives the UI automation and also contains data associated with the automation flow.

The system mitigates recompilation of executable(s) as information (e.g., data and/or command(s)) associated with program flow are generally stored in simple text file(s) thus reducing the need to recompile the executable(s). Thus, modification of these text file(s) can produce new behavior for the executable(s)—update(s) to the program flow only require a modification to these text file(s) and not the engine. Further, the use of simple text file(s) can minimize the time needed to write the UI automation and/or minimize the time for learning use and/or creation of UI automation.

Since many conventional UI automation tools are compiled, creation of UI automation consumes a sizable amount of time. The system can mitigate creation time by allowing user(s) to create UI automation without any substantial knowledge of functionality associated with the system. Further, the system is extensible thus allowing flexibility for future release(s) and/or dynamic change(s) to UI flow without recompilation.

The system includes an input component that receives a request (e.g., command line invocation), and, a navigation component that performs the simulated user interface. The navigation component retrieves mapping information (e.g., section name(s) and page identifier(s)) from a map information store (e.g., map file) and command information (e.g., action(s) to be performed for specific page identifier(s)) from a command information store (e.g., command file). The mapping information maps the automation component (e.g., wizard) into a modular format for use with information stored in the command information store (e.g., command file). The command information store can include information to simulate function key(s) and/or control key(s).

Unlike conventional systems which generally required recompilation, user(s) of the system can make modification(s) to the UI automation by modifying the command information store (e.g., command file) and/or the map information store (e.g., map file).

For example, the navigation component can iterate through the command information store performing the indicated operation(s) and log information associated with the iteration(s) and/or error(s) in a log information store (e.g., log file). Information stored in the log information store can facilitate debugging of problem(s). Information can be stored in the log information store in a short format and/or a verbose format.

Yet another aspect of the present invention provides for the system to access a global information store (e.g., global variable file). The global information store facilitates sharing of a common program flow among a plurality of user(s) with, for example, a difference being custom setting(s) in the global information store (e.g., global variable file).

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a user interface (UI) automation system in accordance with an aspect of the present invention.

FIG. 2 is a listing of an exemplary map information store in accordance with an aspect of the present invention.

FIG. 3 is a listing of an exemplary command information store in accordance with an aspect of the present invention.

FIG. 4 is a table illustrating exemplary commands in accordance with an aspect of the present invention.

FIG. 5 is a table of exemplary action code in accordance with an aspect of the present invention.

FIG. 6 is an exemplary log file in accordance with an aspect of the present invention.

FIG. 7 is a flow chart of a method of automating user interface in accordance with an aspect of the present invention.

FIG. 8 is a flow chart of a method of automating user interface in accordance with an aspect of the present invention.

FIG. 9 is a flow chart further illustrating the method of FIG. 8.

FIG. 10 is a flow chart further illustrating the method of FIGS. 8 and 9.

FIG. 11 is a flow chart further illustrating the method of FIGS. 8-10.

FIG. 12 illustrates an example operating environment in which the present invention may function.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the term “computer component” is intended to refer to a computer-related entity, either hardware, a combination of hardware and software, software, or software in execution. For example, a computer component may be, but is not limited to being, a process running on a processor, a processor, an object, an executable, a thread of execution, a program, and/or a computer. By way of illustration, both an application running on a server and the server can be a computer component. One or more computer components may reside within a process and/or thread of execution and a component may be localized on one computer and/or distributed between two or more computers. Computer components can be stored, for example, on computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the present invention.

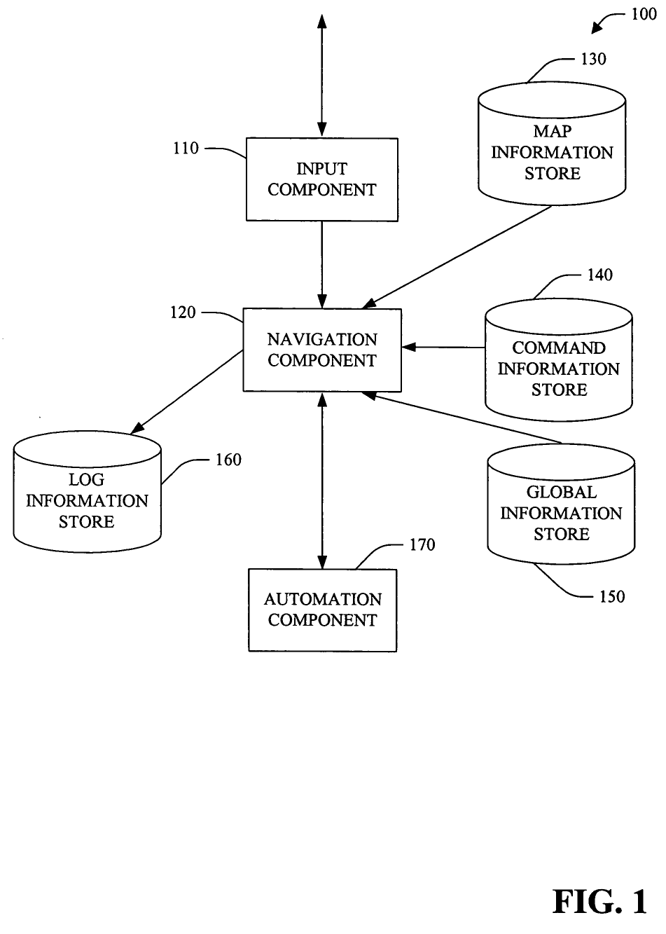

Referring to FIG. 1, a user interface (UI) automation system 100 in accordance with an aspect of the present invention is illustrated. The system 100 includes an input component 110 and a navigation component 120. Optionally, the system can include to a map information store 130, a command information store 140 and/or a global information store 150.

The system 100 facilitates creation of user interface automation (e.g., wizard(s)), for example, by programmer(s) and/or tester(s). The system 100 is based on an architecture which separates data, command(s) and the executable(s), thus facilitating a modular system which can be modified without recompilation of the executable(s). In one example, information associated with the data and/or command(s) are stored in a manner (e.g., text file(s)) that facilitates “on-the-fly” creation/modification via simple text editor(s).

The ability to make modification(s) quickly and efficiently is desirous in user interface automation system(s). Conventional UI automation tool(s) have depended on external dynamic link library(ies) (“DLLs”) which necessitated recompilation in order to make modification(s). Further, many conventional UI automation tool(s) include an engine that drives the UI automation and also contains data associated with the automation flow.

The system 100 mitigates recompilation of executable(s) as information (e.g., data and/or command(s)) associated with program flow are generally stored in simple text file(s) thus reducing the need to recompile the executable(s). Thus, modification of these text file(s) can produce new behavior for the executable(s)—update(s) to the program flow only require a modification to these text file(s) and not the engine. Further, the use of simple text file(s) can minimize the time needed to write the UI automation and/or minimize the time for learning use and/or creation of UI automation.

Since many conventional UI automation tools are compiled, creation of UI automation consumes a sizable amount of time. The system 100 can mitigate creation time by allowing user(s) to create UI automation without any substantial knowledge of functionality associated with the system 100 and/or the navigation component 120. Further, the system 100 is extensible thus allowing flexibility for future release(s) and/or dynamic change(s) to UI flow without recompilation (e.g., via minor update(s) to the map information store 130, the command information store 140 and/or the global information store 150).

Yet another aspect of the present invention provides for launching of the executable and substantially all file(s) necessary from another drive or partition, that is, without copying files to a “test partition”. Many conventional UI automation tool(s) require modification to the environment in order to run. The system 100 thus reduces the need for these modification(s).

Finally, the system 100 can, for example, facilitate unattended silent execution of the engine (e.g., without user interaction). Thus, in one example, the system 100 does not require any substantial user input to run.

The input component 110 receives a request associated with invocation of the system 100. For example, as discussed more fully below, the input component 110 can receive the request via a command line invocation.

The navigation component 120 facilitates simulated user interface associated with an automation component 170 (e.g., wizard) based, at least in part, upon information stored in a map information store 130 (e.g., map file), a command information store 140 (e.g., command file), and, optionally, a global information store 150. In contrast to many convention UI automation tool(s), the system 100 does not depend on external DLLs. The navigation component 120 reduces dependencies of conventional UI automation tool(s) (e.g., which necessitated recompilation), as information associated with program flow is stored in the map information store 130 and/or the command information store 140.

For example, the navigation component 120 can iterate through the command information store 140 performing the indicated operation(s) and log information associated with the iteration(s) and/or error(s) in a log information store 160. Information stored in the log information store 160 can facilitate debugging of problem(s). In one example, the navigation component 120 stores information associated with substantially every action taken in the log information store 160.

The map information store 130 (e.g., map file) stores mapping information associated with the automation component 170 (e.g., wizard). In accordance with an aspect of the present invention, alias name(s) (e.g., friendly name mapping) can be employed with the map information store 130 and/or the command information store 140, which can facilitate ease of command comprehension. Thus, for example, user(s) can quickly generate command line files and/or modify actions, using alias name(s) rather than a cryptic language.

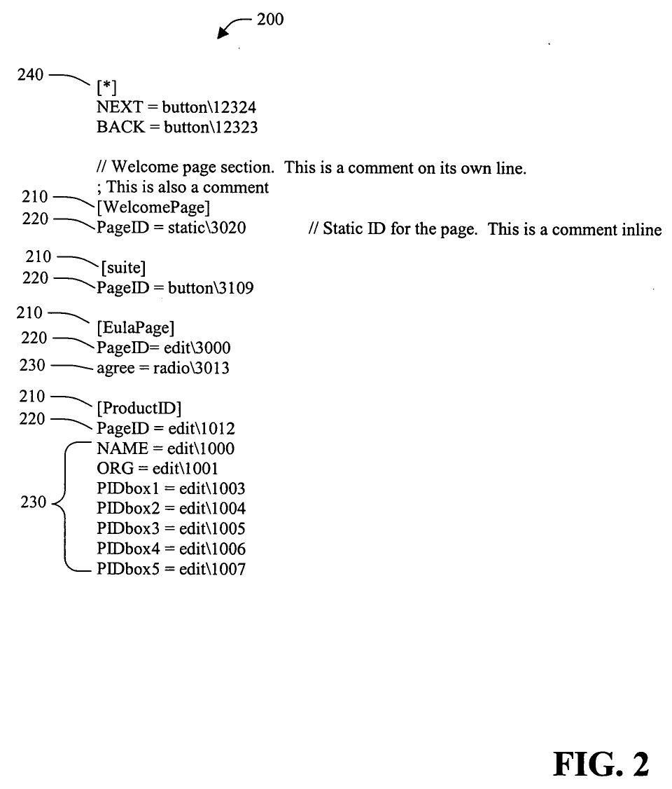

Turning briefly to FIG. 2, an exemplary map information store 200 in accordance with an aspect of the present invention is illustrated. The map information store 200 includes section name(s) 210 (e.g., surrounded in brackets). The section name(s) 210 divide the map information store 200 into specific page data where a specific section name 210 references a specific page of an associated automation component (e.g., wizard). Generally, there is a corresponding section in an associated command information store 140 (e.g., command file).

Generally a page identifier 220, for example, of the form “PageID=control type\number” follows a section name 210. The page identifier 220 is a label for a control that uniquely identifies a particular page. The control type and number can be found on the associated automation component 170 (e.g., wizard using, for example, SPY and/or WINFO). For example, the control type can be one of the following: button, combo, list, scroll, static, radio and/or check. The number (e.g., decimal number) gives a unique ID for the control.

In the example of FIG. 2, next follows a line of the form “friendly name =control type∴number”. A friendly name 230 of the control can be used in the command information store 140 (e.g., command file), for example, for ease of use. The control type and id can be found in the same manner described previously. For those control(s) that fall on more than one page (e.g., “back”, “next”, “cancel”), a special section labeled [*] 240 can be used to list these friendly name data.

Optionally, comment(s) can be created on their own line, for example, with “//” or “;”. In this example, if comment(s) are used on the same line as a command, then they follow the command and can are marked via “//”.

Returning to FIG. 1, the command information store 140 stores command information associated with the automation component 170. It contains the information about which page to look for and what action(s) to execute for a given page.

The command information store 140 (e.g., command file) can be modified via custom front-end UI-type application(s). Additionally, command modification(s) to information stored in the command information store 140 (e.g., command file) can be made via scripting, batch file(s) and/or text editor(s). Thus, a user of the system 100 can quickly modify the command information store 140 (e.g., command file) without recompilation of the navigation component 120.

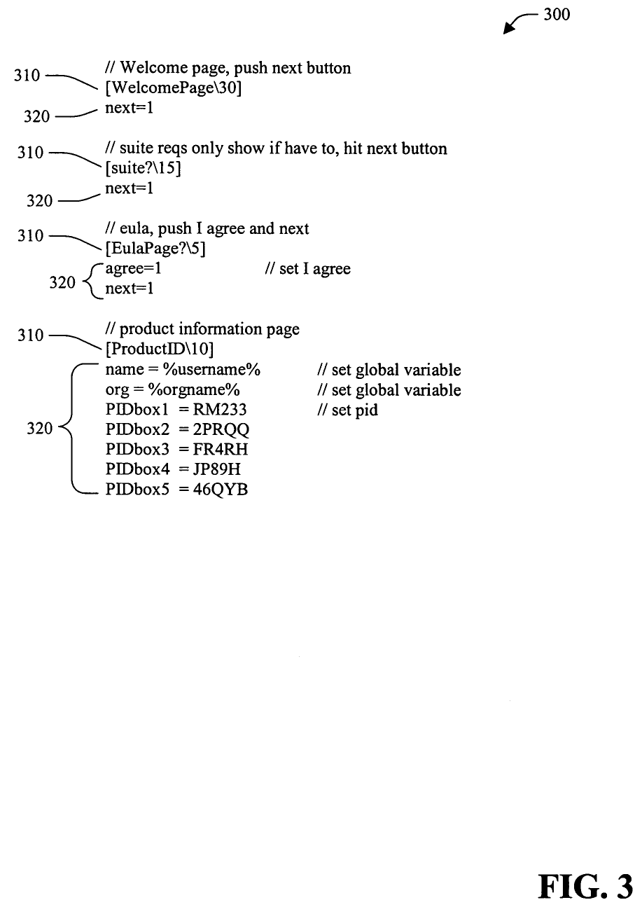

Turning briefly to FIG. 3, an exemplary command information store 300 in accordance with an aspect of the present invention is illustrated. The command information store 300 includes section name(s) 310, for example, surrounded by brackets. The section name(s) 310 is a name that denotes a unique page and corresponds to section name(s) of the map information store 130 (e.g., section name(s) 210). Additionally, immediately following the section name(s) 310, optionally, there can be a question mark which indicates that the page is optional. In other words, the automation can continue if the page is not found within a specified time period. The amount of time to search for a page can be given, for example, by a number that directly follows a backslash. If no number is indicated, a default period of time can be employed (e.g., a default of 20 seconds).

For example, “[Welcome?\60]” corresponds to a section in the map information store 130 (e.g., mapping file) also named “Welcome”. The “?” indicates that this page is optional and the automation should continue on to the next section if it does not encounter the page within 60 seconds. Section data 320 is associated with section name(s) 310. Generally, the section data is of the form “command=data”.

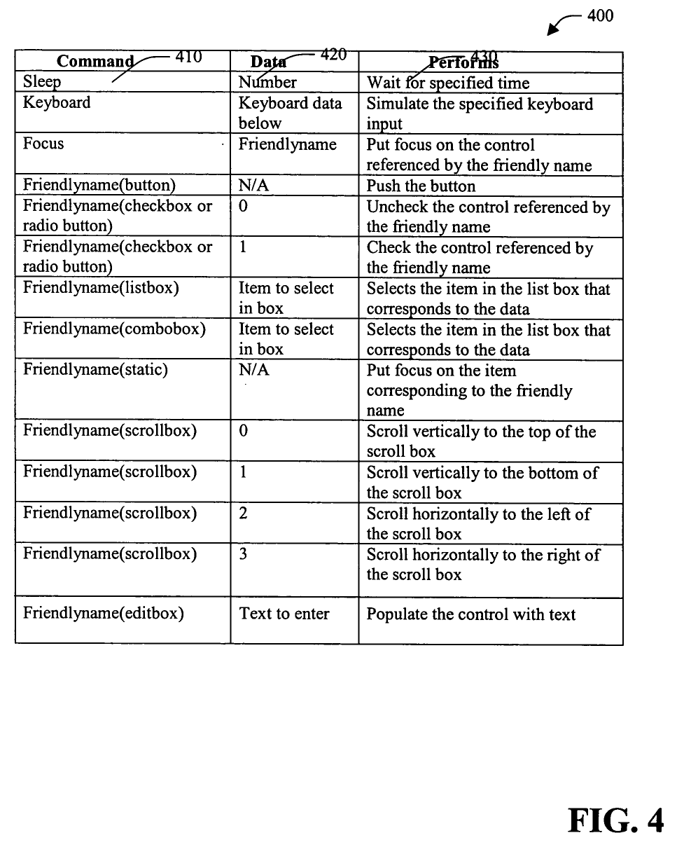

Next, referring to FIG. 4, a table 400 illustrating exemplary commands in accordance with an aspect of the present invention are illustrated. The label “friendlyname” refers to a name used in a map information store 130 that references that specific type of control. The table 400 identifies commands 410, data 420 and action(s) 430.

Returning to FIG. 1, the optional global information store 150 stores information associated with global variable(s) and, thus, facilitates variable replacement from a single location. This allows a set of information that is configurable to be placed in another location (e.g., global information store 150).

The global information store 150 generally includes a section labeled [Global]. The section data is of the form %globalvariable%=data. Whenever a global variable is encountered in the command information store 140 (e.g., command file), it is replaced with the corresponding data from the global information store 150 (e.g., global.txt file). For example:
[Global]
%orgname%=Micro soft
%usemname%=DefaultTester
   In this example, the global variables “orgname” and “username” will be replaced with their values, “Microsoft” and “DefaultTester”, respectively, when they are encountered in the command information store 140 (e.g., command file).

Thus, the navigation component 120 is able to obtain this data from the global information store 150 facilitating sharing of a common program flow among a plurality of user(s) with, for example, a difference being custom setting(s) in the global information store 150 (e.g., global variable file). This can facilitate code reuse and/or sharing of data which can lead, for example, to quicker modification(s).

Thus, in example of FIG. 4, data in the data section 420 of the table 400 can be replaced by a %globalvariable%. The % indicates that this data is a global variable and that the actual data can be found in a global information store 150 (e.g., file named “global.txt” located in the calling directory). As discussed previously, the global information store 150 generally includes a section labeled [Global]. The section data is of the form %globalvariable%=data. Whenever a global variable is encountered in the command file, it is replaced with the corresponding data from the global information store 150 (e.g., global.txt file).

Referring back to FIG. 1, the command information store 140 can further include information to simulate function key(s) and/or control key(s). For example, function key(s) and/or control key(s) can be simulated by sending special escape sequences (e.g., similar to “SendKeys” method for the Windows Script Host). For example: {ESC} is Escape and {TAB} is Tab.

Additionally, parentheses can be employed to group and/or combine modifiers. For example, the following sequence from Visual C++ invokes the Options, Tools dialog, selects the second tab, selected an item in a combo box, sets a radio button, returns to the first tab and presses OK (e.g., Alt+T, o, Ctrl+Tab, c, Alt+n, Ctrl+Shift+Tab, Enter).
Keyboard=“% to\hat{ }({tab})c % n\hat{ }(+({tab}))˜”

In one example, to specify a single keyboard character, the character itself is used (e.g., to represent the letter A, “A” is used for the key text). However, to represent more than one character, each additional character is appended to the one preceding it. For example, to represent the letters A, B, and C, “ABC” is used for the key text.

In this example, the plus sign (+), caret (\hat{ }), percent sign (%), tilde (˜), parentheses ( ), brackets [ ], and braces { } have special meanings. To specify one of these characters, the character is enclosed inside braces. For example, to specify the plus sign, {+} is used. To specify brace characters, {{ } and { }} is used.

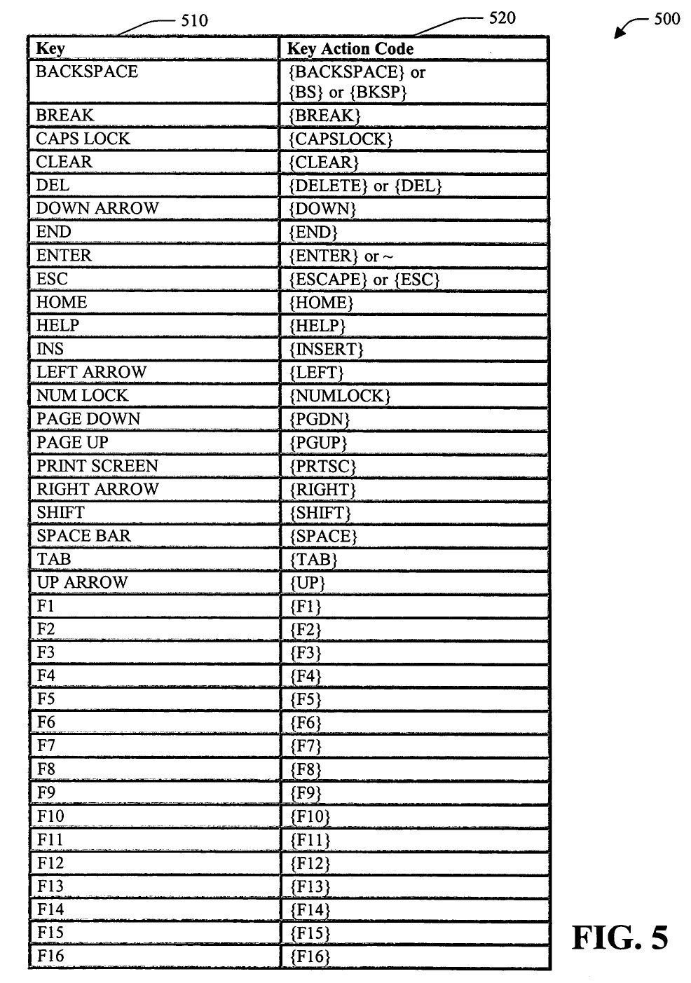

Referring briefly to FIG. 5, a table 500 of exemplary action code in accordance with an aspect of the present invention is illustrated. The table 500 sets for keys 510 and associated an associated key action code 520.

Additionally, in order to specify key(s) combined with combination(s) of SHIFT, CTRL and/or ALT key(s), the regular key text is preceded with one of more of the following key action codes:

TABLE 1

| Key | Key Action Code |
|---|---|
| SHIFT | + |
| CTRL | \hat{ } |
| ALT | % |

To specify that SHIFT, CTRL, and/or ALT should be held down while several other keys are pressed, the key text is enclosed inside parentheses. For example, to represent holding down the CTRL key while the letters e and c are pressed, use “\hat{ }(ec)”. To represent holding down CTRL while the letter e is pressed, followed by the letter c being pressed without CTRL, use “\hat{ }ec”.

To specify repeating keys, use the form {keytext number}. In this example, there is a space between the key text and the number. For example, {LEFT 42} represents pressing the left arrow key forty two times; {h 10} represents pressing the letter h ten times. Optionally, comment(s) can be made inline by placing //. That is, text after these slashes is ignored until the next line.

In one example, the system 100 can be invoked via a command line with command line option(s) received by the input component 110. For example, the command line invocation can be of the form:
Navigation /f commandfile /m mapfile </l logfile></v>
   where “Navigation” refers to invocation of the system 100.

In this example, the /f option is required and it specifies the command information store 140 (e.g., command file). If a full path name is not specified, it will assume the file is in the local directory. The /m option is required and it specifies the map information store 130 (e.g., mapping file). If a full path name is not specified, it will assume the file is in the local directory.

The /l option is optional and it specifies a log information store 160 (e.g., log file). If a full path name is not specified, it will assume the file is in the local directory. If this option is not used, then the log information store 160 (e.g., log file named nav.log) will be created in the calling directory. The /v option is optional and it specifies verbose logging. The default is to show only error codes. The /? Option will bring up a message box showing these command line options.

In one example, there is input validation by the input component 110 for the mapping and command files used. If there is a problem with either one, then an error will be returned to the user by the input component 110. For example, if the input to the system 100 is incorrect or if there is any problem opening the map information store 130, the command information store 140, the global information store 150 and/or the log information store 160, then a message box will be displayed to the user indicating the problem. Other than that, in this example, no other UI is shown to the user. Instead, the program returns a result code when it finishes, for example:
0—everything was successful
1—problem with the command line information or input files
2—unable to detect a page
3—unable to find a control or perform an indicated operation

As discussed previously, the navigation component 120 can log information associated with action(s), iteration(s) and/or error(s) in the log information store 160. The log information store 160 (e.g., log file) can be generated as information is processed by the navigation component 120. For example, the information stored can be a verbose form or a short form (e.g., based, at least in part, upon a user's selection). The short form can, for example, store error message(s) of the verbose form.

In one example, the verbose form stores information including a time and date stamp, the word ERROR if this is an error message and, a status message in any given line. Error messages indicate abnormal program behavior or a state that the user was not expecting. These errors should indicate what the problem was and at what line of the command file the problem was encountered in.

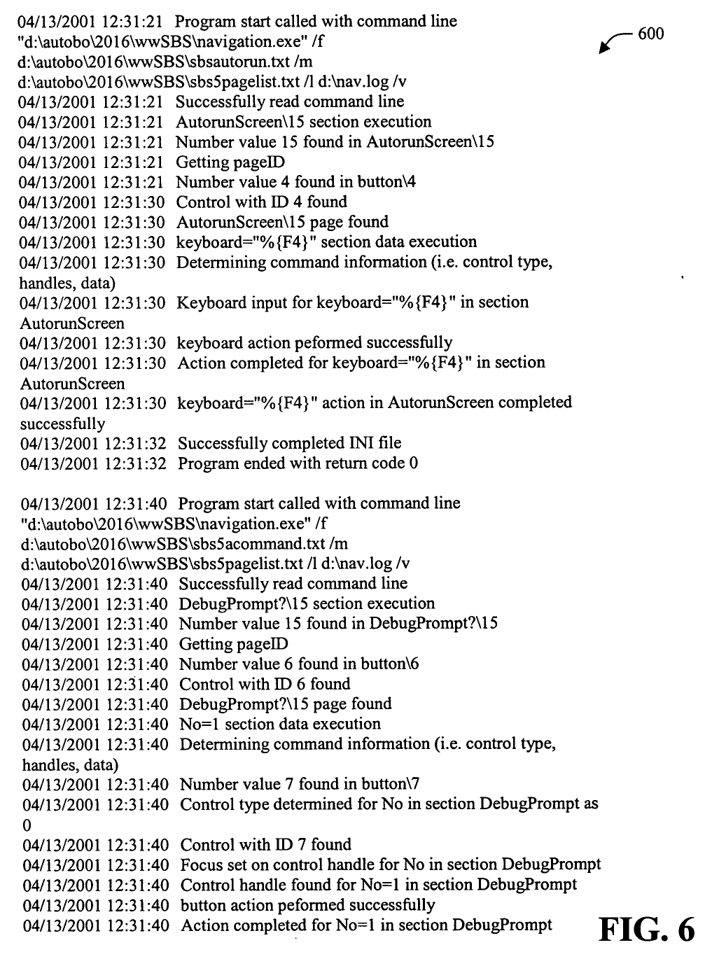

Turning to FIG. 6, an exemplary log file 600 in accordance with an aspect of the present invention is illustrated. In this example, there are several important status messages in the log information store 160 (e.g., log file). The first 610 is at the start of each execution of the system 100 and it contains the command line with which the system 100 was launched. The second important status message 620 is what section is currently being processed followed by the section data currently being processed. This can facilitate isolation of problem(s) encountered. Status messages also indicate the ID of the control that is being used by the navigation component 120, whether its handle was found, whether an indicated action was performed successfully, etc. Additionally, the log information store 160 can be opened in “append mode” so that no previous log(s) are lost.

It is to be appreciated that the system 100, the input component 110, the navigation component 120, the map information store 130, the command information store 140, the global information store 150, the log information store 160 and/or the automation component 170 can be computer components as that term is defined herein.

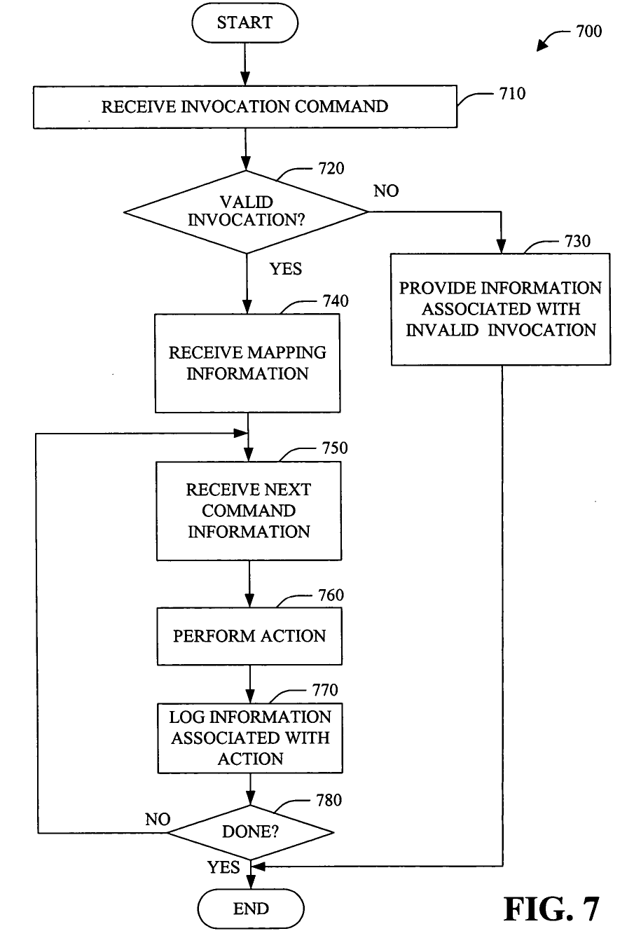

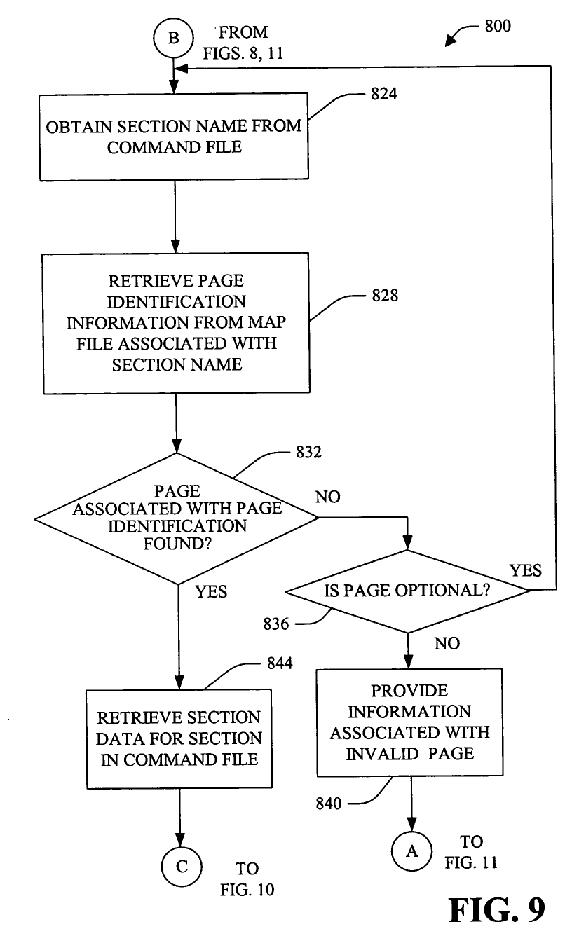

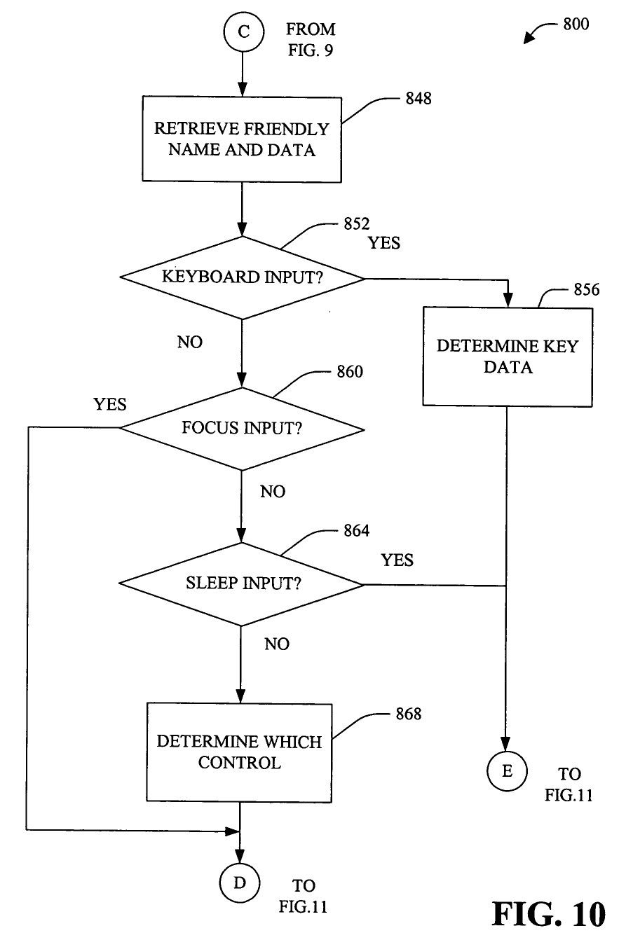

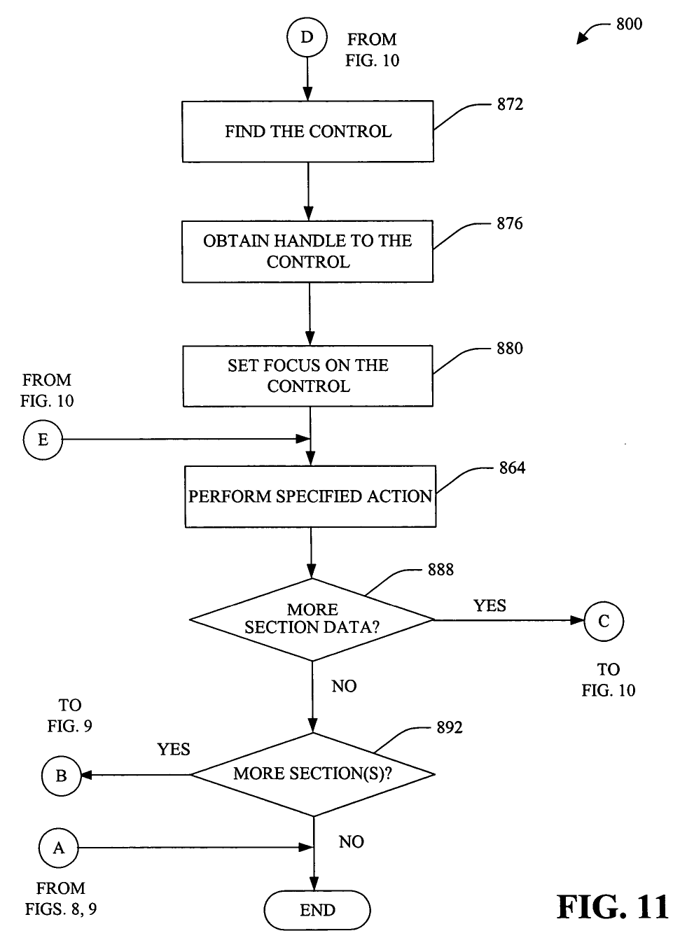

Turning briefly to FIGS. 7-11, methodologies that may be implemented in accordance with the present invention are illustrated. While, for purposes of simplicity of explanation, the methodologies are shown and described as a series of blocks, it is to be understood and appreciated that the present invention is not limited by the order of the blocks, as some blocks may, in accordance with the present invention, occur in different orders and/or concurrently with other blocks from that shown and described herein. Moreover, not all illustrated blocks may be required to implement the methodologies in accordance with the present invention.

The invention may be described in the general context of computer-executable instructions, such as program modules, executed by one or more components. Generally, program modules include routines, programs, objects, data structures, etc. that perform particular tasks or implement particular abstract data types. Typically the functionality of the program modules may be combined or distributed as desired in various embodiments.

Referring to FIG. 7, a method 700 of automating user interface in accordance with an aspect of the present invention is illustrated. At 710, an invocation command is received. At 720, a determination is made as to whether the invocation command is valid. If the determination at 720 is NO, at 730, information associated with the invalid invocation is provided (e.g., stored in a log information store 160, log file and/or provided to a user).

If the determination at 720 is YES, at 740, mapping information is received (e.g., from a map information store 130 and/or mapping file). At 760, the next command information is received, for example, from the command information store 140 and/or a command file. At 760, an action associated with the received command is performed. At 770, information associated with the information is logged (e.g., in a log information store 160 and/or a log file).

At 780, a determination is made as to whether the UI automation is done (e.g., last command in the command information store 140 executed). At the determination at 780 is NO, processing continues at 750. If the determination at 780 is YES, no further processing occurs.

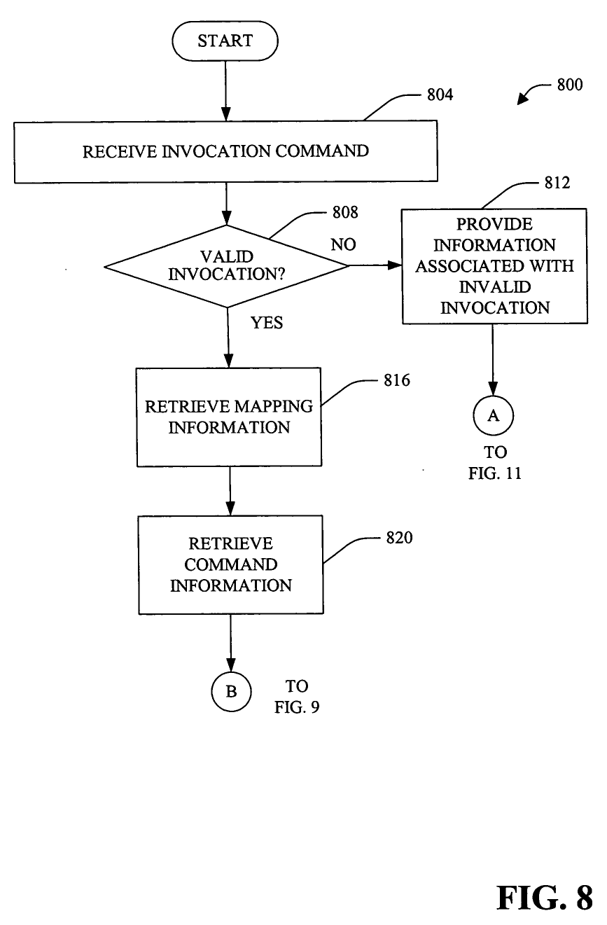

Next, referring to FIGS. 8-11, a method 800 of automating user interface in accordance with an aspect of the present invention is illustrated. At 804, an invocation command is received. At 808, a determination is made as to whether the invocation command is valid. If the determination at 808 is NO, at 812, information associated with the invalid invocation is provided (e.g., stored in a log information store 160, log file and/or provided to a user), and no further processing occurs.

If the determination at 808 is YES, at 816, mapping information is retrieved from a map file. At 820, command information is retrieved from a command file. At 824, a section name is obtained from the command file. At 828, page identification information (e.g., PageID) associated with the section name is retrieved from the map file.

At 832, a determination is made as to whether a page associated with the page identification information (e.g., PageID) has been found. If the determination at 832 is NO, at 836, a determination is made as to whether the page is optional. If the determination at 836 is YES, processing continues at 824. If the determination at 836 is NO, at 840, information associated with the invalid page is provided, and, no further processing occurs.

If the determination at 832 is YES, at 844, section data for the section is retrieved from the command file. At 848, friendly name and data is retrieved. At 852, a determination is made as to whether the retrieved data simulates a keyboard input. If the determination at 852 is YES, at 856, the simulated keyboard input is determined and processing continues at 884.

If the determination at 852 is NO, at 860, a determination is made as to whether the retrieved data simulates a focus input. If the determination at 860 is YES, processing continues at 872. If the determination at 860 is NO, at 864, a determination is made as to whether the retrieved data simulates a sleep input. If the determination at 864 is YES, processing continues at 872. If the determination at 864 is NO, at 868, the simulated control is determined.

Next, at 872, the control is found. At 876, a handle to the control is obtained. At 880, focus is set on the control. At 884, the specified action is performed.

At 888, a determination is made as to whether more section data exists. If the determination at 888 is YES, processing continues at 848. If the determination at 888 is NO, at 892, a determination is made as to whether more sections exist. If the determination at 892 is YES, processing continues at 824. If the determination at 892 is NO, no further processing occurs.

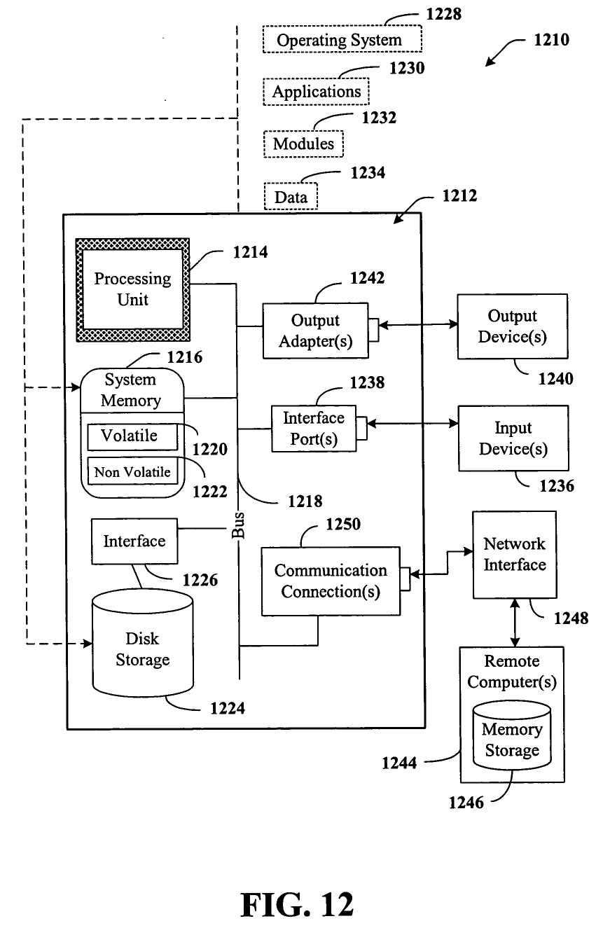

In order to provide additional context for various aspects of the present invention, FIG. 12 and the following discussion are intended to provide a brief, general description of a suitable operating environment 1210 in which various aspects of the present invention may be implemented. While the invention is described in the general context of computer-executable instructions, such as program modules, executed by one or more computers or other devices, those skilled in the art will recognize that the invention can also be implemented in combination with other program modules and/or as a combination of hardware and software. Generally, however, program modules include routines, programs, objects, components, data structures, etc. that perform particular tasks or implement particular data types. The operating environment 1210 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 12, an exemplary environment 1210 for implementing various aspects of the invention includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, an 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable ROM (EEPROM), or flash memory. Volatile memory 1220 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1212 also includes removable/nonremovable, volatile/nonvolatile computer storage media. FIG. 12 illustrates, for example a disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in suitable operating environment 1210. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the present invention can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212, and to output information from computer 1212 to an output device 1240. Output adapter 1242 is provided to illustrate that there are some output devices 1240 like monitors, speakers, and printers among other output devices 1240 that require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A user interface automation system comprising:
an input component that receives a request; and,
a navigation component that receives the request from the input component and facilitates simulated user interface associated with an automation component based, at least in part, upon information stored in a map information store and information stored in a command information store.

2. The system of claim 1, wherein the automation component is a wizard.

3. The system of claim 1, wherein the map information store comprises a text-based file.

4. The system of claim 1, wherein the configuration information store comprises a text-based file.

5. The system of claim 1, wherein the navigation component further facilitates simulated user interface based, at least in part, upon information stored in a global information store.

6. The system of claim 5, the navigation component employing information stored in the global information store when a global variable is encountered in the command information store.

7. The system of claim 1, wherein at least one of the map information store and the configuration information store comprise at least one alias name.

8. The system of claim 1, wherein the navigation component further stores error information in a log information store.

9. The system of claim 1, wherein the navigation component further stores information associated with the request in a log information store.

10. The system of claim 9, wherein the navigation component iterates through information stored in the command information store, performs the indicated operation and stores information associated with the indicated operation in the log information store.

11. The system of claim 9, wherein the navigation component stores error information in the log information store.

12. The system of claim 1, wherein the input component performs input validation upon the request and provides error information if the request is invalid.

13. The system of claim 12, wherein a graphical message is displayed to a user of the system, the graphical message being based, at least in part, upon the error information from the input component.

14. The system of claim 1, wherein the input component receives a command line invocation.

15. The system of claim 1, the map information store comprising a section name and a page identifier.

16. The system of claim 15, the page identifier comprising a label for a control, the page identifier further uniquely identifying a particular page.

17. The system of claim 15, the page identifier comprising a control type.

18. The system of claim 17, wherein the control type is at least one of button, combo, list, scroll, static, radio and check.

19. The system of claim 1, wherein information stored in the command information store can be modified by at least one of a front-end user interface application, scripting, a batch file and a text editor.

20. The system of claim 1, the command information store comprising a section name, the section name corresponding to information stored in the map information store, the command information store further comprising an action.

21. The system of claim 1, the command information store storing information associated with at least one of a function key and a control key simulation.

22. A method of automating user interface comprising:
receiving mapping information from a map information store;
receiving command information from a command information store;
performing simulated user interface based, at least in part, upon information stored in the map information store and the command information store.

23. The method of claim 22, further comprising:
storing information in a log information store, if an error is detected performing the simulated user interface.

24. A computer readable medium having stored thereon computer executable instructions for carrying out the, method of claim 22.

25. A method of automating user interface comprising:
retrieving mapping information from a map file;
retrieving command information from a command file;
obtaining a section name from the command file;
retrieving page identification information from the map file associated with the section name;
retrieving section data for section associated with the section name from the command file; and,
performing an action associated with the retrieved section data.

26. The method of claim 25, further comprising:
storing information in a log file, if an error is detected performing the action.

27. A computer readable medium having stored thereon computer executable instructions for carrying out the method of claim 25.

28. A user interface automation system comprising:
an input component that receives a request; and,
a navigation component that receives the request from the input component and facilitates simulated user interface associated with an automation component based, at least in part, upon information stored in a map information store and information stored in a command information store.

29. A user interface automation system comprising:
means for receiving a request; and,
means for simulating user interface associated with an automation component based, at least in part, upon information stored in a map information store and information stored in a command information store, the means for simulating receiving the request from the means for receiving.

30. A data packet transmitted between two or more computer components that facilitates user interface simulation, the data packet comprising:
a section name and a page identifier that uniquely identifies a particular page, the page identifier comprising a label for a control and a control type.
